(19) United States
(12) Patent Application Publication
(10) Pub. No.: US 2025/0215794 A1
(43) Pub. Date: Jul. 3, 2025

(54) FLUID SAMPLING TOOL AND SAMPLE CHAMBER FOR CHEMICALLY ACTIVE COMPONENT MEASUREMENT

(71) Applicant: Halliburton Energy Services, Inc., Houston, TX (US)

(72) Inventors: Wael Soliman Elhawary, Katy, TX (US); Christopher Michael Jones, Katy, TX (US)

(73) Assignee: Halliburton Energy Services, Inc., Houston, TX (US)

(21) Appl. No.: 18/402,879

(22) Filed: Jan. 3, 2024

(51) Int. Cl. G01N 1/14; E21B 49/08; G01N 1/10; G01N 33/28; G01V 9/00

(52) U.S. Cl. CPC E21B 49/0875; E21B 49/081; E21B 49/10

(57) ABSTRACT

A fluid sampling tool is locatable in a borehole for sampling formation fluid including a chemically active component from a formation. The fluid sampling tool includes a sample chamber including a fluid inlet and an interior, wherein the interior includes a substrate and a reagent attached to the substrate, and wherein the reagent is configured to react with the chemically active component of the formation fluid to form a reaction product. The fluid sampling tool also includes a pump operable to pump a sample of the formation fluid in from the formation through the probe and into the sample chamber. A formation fluid sample flows into the sample chamber and a chemically active component of the formation fluid sample reacts with the reagent to form the reaction product from which a presence and concentration of the chemically active component in the formation fluid sample is determinable

### BACKGROUND

Hydrocarbon fluids, including oil and natural gas, are obtained from boreholes drilled into subterranean formations (or simply “formations”) having hydrocarbon-rich reservoirs. After the borehole is drilled, the well is completed by installation of specially designed equipment and materials to facilitate and control hydrocarbon production.

It is often desired to collect a representative sample of formation or reservoir fluids (e.g., hydrocarbons) to further evaluate drilling operations and production potential, or to detect or determine the presence and concentration of certain gases or other materials in the formation fluids that may affect well performance. For example, hydrogen sulfide (H₂S), a poisonous, corrosive, and flammable gas can occur in formation fluids, and its presence in the borehole in significant concentrations may result in damage to borehole components or dangerous conditions for well operators at the surface. However, H₂S concentration in formation fluids is often underestimated with existing measurement techniques, for example, due to losses via absorption/adsorption on tool surfaces and/or during sample transfers.

### BRIEF DESCRIPTION OF THE DRAWINGS

Aspects of the disclosure are described with reference to the following figures, the features of which are not necessarily shown to scale. Some details of elements may not be shown or may be represented by conventional symbols in the interest of clarity and conciseness.

FIG. 1A illustrates a schematic view of a well in which an example embodiment of a fluid sample system is deployed.

FIG. 1B illustrates a schematic view of another well in which an example embodiment of a fluid sample system is deployed.

FIG. 2 illustrates a schematic view of an example embodiment of a fluid sampling tool.

FIG. 3 illustrates an enlarged schematic view of an example embodiment the fluid sampling tool of FIG. 2.

FIGS. 4A-4C illustrate a cross-sectional view an example embodiment of a sample chamber in the sampling tool of FIGS. 2 and 3.

FIGS. 5A-5C illustrate cross-sectional views from orthogonal planes of another example embodiment of a sample chamber in the sampling tool of FIGS. 2 and 3.

FIG. 6 illustrates an example diagram of an example test system for chemically active component measurement.

### DETAILED DESCRIPTION

The present disclosure relates to subterranean operations and, more particularly, embodiments disclosed herein provide methods and systems for capture and measurement of a chemically active component in a formation fluid.

Embodiments may include sampling of formation fluid from a borehole extending in a formation to determine a presence and a concentration of a chemically active component in the formation fluid. A chemically active component may include any of a variety of gases, vapors, or liquids, where quantification in formation fluids may be desired, including, but not limited to, H₂S, organic acids, mercury, and carbon dioxide, among others. By way of example, H₂S is a volatile chemical that oxidizes easily, is corrosive to downhole tools, and is poisonous and explosive. The presence of H₂S in a formation may increase the cost of extracting and processing formation fluids from a well and also present a safety hazard to well operators. Accurate measurement of H₂S (or other chemically active components) in the formation fluids can better enable well operators to make decisions about completing a well so that formation fluids can be economically extracted while maintaining safe conditions for well operators. In addition, it may desirable to know concentration of mercury and carbon dioxide as well, as these components can also be corrosive.

The fluid sampling tools described herein may vary in design, but embodiments of the fluid sampling tools typically may include an inlet, an outlet, and a sample chamber. Embodiments may further include two or more sample chambers. The inlet and outlet may be fluidly connected to the fluid being extracted from a subterranean formation. In operation, a fluid sample may be gathered into the sample chamber from the borehole for analysis. Embodiments may include a sample chamber, the interior of which includes a substrate and a reagent attached to the substrate, and wherein the reagent is configured to react to the chemically active component of the formation fluid such that the presence and concentration of the chemically active component is determinable. At a desired time, for example, either downhole or after recovery of the sample tool to the well surface, the presence and amount of the chemically active component can be determined by detecting a reaction product of the chemically active component and the reagent. Given a known volume of formation fluid sampled and amount of chemically active component determinable from the amount of a detected reaction product, the concentration of the chemically active component in the sample of formation fluid can be determined using a processor. Multiple component measurements from multiple sample chambers (e.g., two or more) may be obtained. The component measurements may be obtained at different times in the borehole. In this manner, the technology of formation fluid sampling and chemically active component analysis is improved because of the ability to control interaction of the reagent with the formation fluid. Direct introduction of the reagent into a flow stream of the formation fluid is undesirable in some circumstances. This is because constant contact of the reagent with the flow stream may consume the reagent in its entirety. Even if not, constant contact of the reagent with the flow stream makes quantification of the concentration of the active component difficult. The present disclosure makes technological improvements by, among others, including a reagent/substrate arrangement inside the sample chamber as well as controlling the interaction of the reagent with the formation fluid to overcome these issues.

The fluid sampling tools, systems, and methods described herein may be used with any of the various techniques employed for evaluating a well, including without limitation wireline formation testing (WFT), measurement while drilling (MWD), and logging while drilling (LWD). The various tools and sampling units described herein may be delivered downhole as part of a wireline-delivered downhole assembly or as a part of a drill string. It should also be apparent that given the benefit of this disclosure, the apparatuses and methods described herein have applications in downhole operations other than drilling, and may also be used after a well is completed.

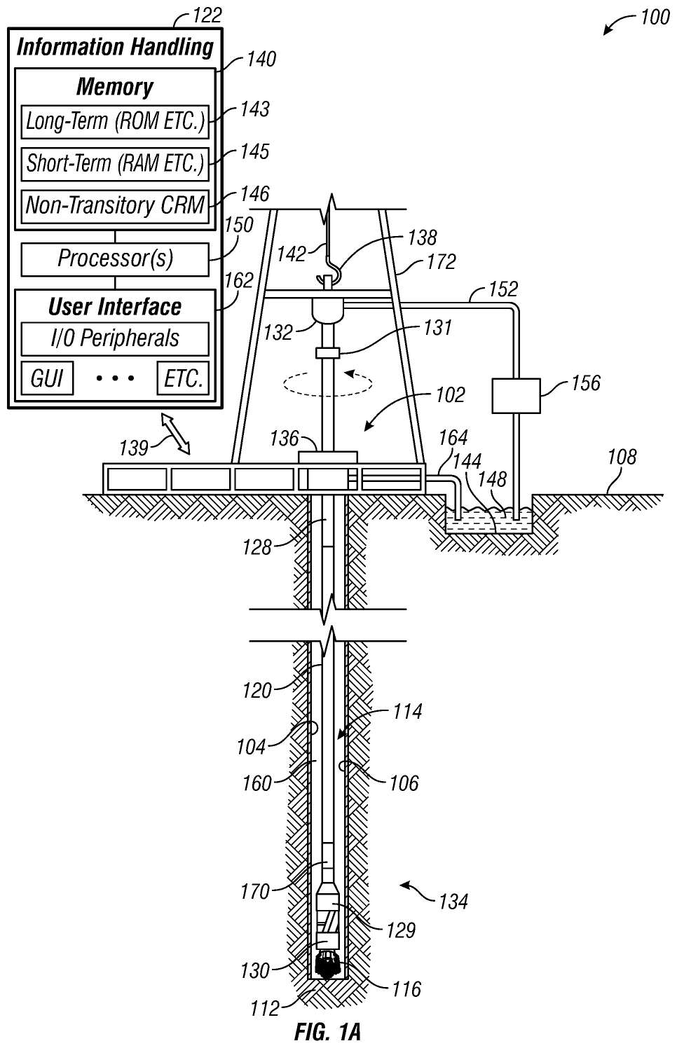

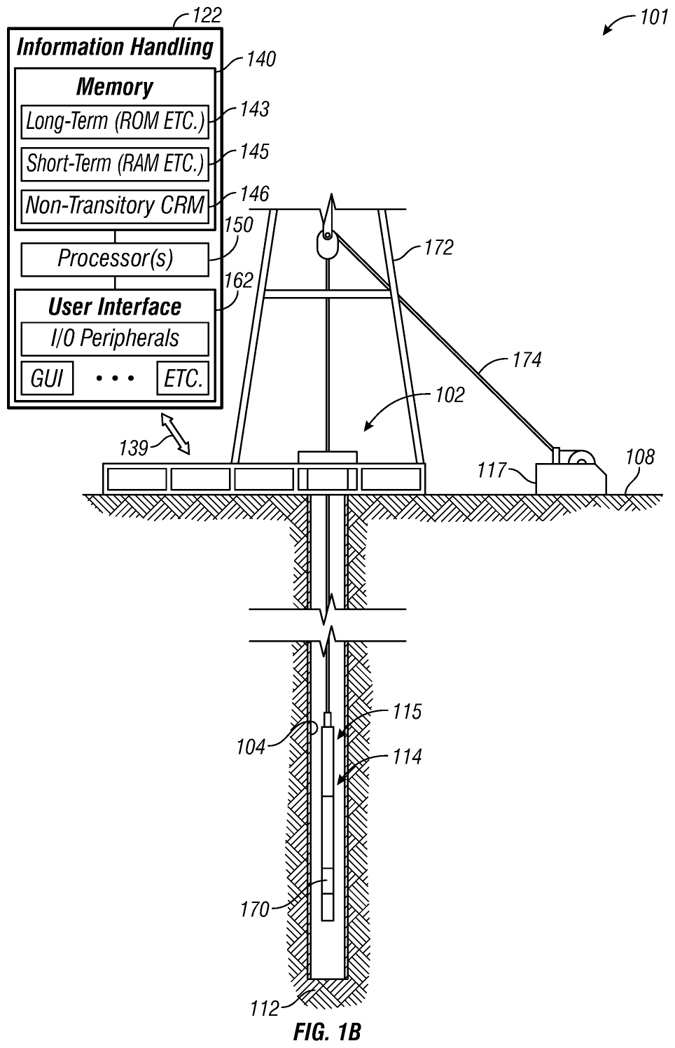

FIG. 1A illustrates a fluid sampling and analysis system 114 according to an illustrative embodiment used in a well 102 having a borehole 104 that extends from a surface 108 of the well 102 to or through a subterranean formation 112. While the borehole 104 is shown extending generally vertically into the subterranean formation 112, the principles described herein are also applicable to boreholes that extend at an angle through the subterranean formations 112, such as horizontal and slanted boreholes. For example, although FIG. 1A shows borehole 104 that is vertical or low inclination, high inclination angle or horizontal placement of the borehole 104 and equipment is also possible. In addition, it should be noted that while FIG. 1A generally depicts a land-based operation, those skilled in the art should readily recognize that the principles described herein are equally applicable to subsea operations that employ floating or sea-based platforms and rigs, without departing from the scope of the disclosure.

The well 102 is illustrated with the fluid sampling and analysis system 114 being deployed in a drilling system 100. In the embodiment illustrated in FIG. 1A, the well 102 is formed by a drilling process in which a drill bit 116 is turned by a drill string 120 that extends from the drill bit 116 to the surface 108 of the well 102. The drill string 120 may be made up of one or more connected tubes or pipes, of varying or similar cross-section. The drill string 120 may refer to the collection of pipes or tubes as a single component, or alternatively to the individual pipes or tubes that include the string. The term “drill string” is not meant to be limiting in nature and may refer to any component or components that are capable of transferring rotational energy from the surface of the well to the drill bit 116. In several embodiments, the drill string 120 may include a central passage disposed longitudinally in the drill string 120 and capable of allowing fluid communication between the surface 108 of the well 102 and downhole locations.

At or near the surface 108 of the well 102, the drill string 120 may include or be coupled to a kelly 128. The kelly 128 may have a square, hexagonal, octagonal, or other suitable cross-section. The kelly 128 is shown connected at one end to the remainder of the drill string 120 and at an opposite end to a rotary swivel 132. As illustrated, the kelly 128 passes through a rotary table 136 that is capable of rotating the kelly 128 and thus the remainder of the drill string 120 and drill bit 116. The rotary swivel 132 allows the kelly 128 to rotate without rotational motion being imparted to the rotary swivel 132. A hook 138, cable 142, traveling block (not shown), and hoist (not shown) may be supported by a rig 172 and provided to lift or lower the drill bit 116, drill string 120, kelly 128, and rotary swivel 132. The kelly 128 and swivel 132 may be raised or lowered as needed to add additional sections of tubing to the drill string 120 as the drill bit 116 advances, or to remove sections of tubing from the drill string 120 if removal of the drill string 120 and drill bit 116 from the well 102 is desired.

A reservoir 144 may be positioned at the surface 108 and holds drilling fluid 148 for delivery to the well 102 during drilling operations. A supply line 152 fluidly couples the reservoir 144 and the inner passage of the drill string 120. A pump 156 is capable of pumping the drilling fluid 148 through the supply line 152 and downhole to lubricate the drill bit 116 during drilling and to carry cuttings from the drilling process back to the surface 108. After traveling downhole, the drilling fluid 148 returns to the surface 108 by way of an annulus 160 formed between the drill string 120 and the borehole 104. At the surface 108, the drilling mud 148 is returned to the reservoir 144 through a return line 164. The drilling mud 148 may be filtered or otherwise processed prior to recirculation through the well 102.

The drilling system 100 may comprise a bottom hole assembly (BHA) 134 coupled to the drill string 120 near the drill bit 116. The BHA 134 may comprise various downhole measurement tools and sensors and LWD and MWD elements, including the fluid sampling and analysis system 114. As illustrated, the BHA 134 may include a fluid sampling tool 170 that is part of the fluid sampling and analysis system 114. The tools and sensors of the BHA 134, including the fluid sampling and analysis system 114, may be communicably coupled to a telemetry system 129. The telemetry system 129 is operable to transfer measurements from the fluid sampling and analysis system 114 to a surface receiver 131 and/or to receive commands from the surface receiver 131. The telemetry system 129 may comprise a mud pulse telemetry system, and acoustic telemetry system, a wired communications system, a wireless communications system, or any other type of communications system that would be appreciated by one of ordinary skill in the art in view of this disclosure. In certain embodiments, some or all of the measurements taken by the fluid sampling and analysis system 114 may also be stored within the BHA 134 or the telemetry system 129 for later retrieval at the surface 108.

The BHA 134 may further include a rotary steerable tool (RSS) 130 operable to provide directional control while drilling the borehole 104 from the surface 108 of the well site down into the formation 112. For example, the RSS 130 may be a “push the bit” type system that uses coordinated movement of pad pushers against the borehole 104 to urge the drill bit 116 in a particular direction. Alternatively, the RSS 130 may be a “point the bit” type system that can adjust the orientation of a drill bit axis relative a body of the RSS 130 in order to point the drill bit 116 in the desired direction. Directional drilling may result in any number of horizontal, vertical, slanted, curved, and other types of wellbore geometries and orientations to achieve a desired wellbore path.

The drilling system 100 may also comprise an information handling system 122 positioned at the surface 108. The information handling system 122 may be communicably coupled to the surface receiver 131 and may receive measurements from the fluid sampling and analysis system 114 and/or transmit commands to the fluid sampling and analysis system 114 though the surface receiver 131. The information handling system 122 may also receive measurements from the fluid sampling and analysis system 114 when the system 114 is retrieved at the surface 108. As will be described below, the information handling system 122 may process the measurements to determine certain characteristics of formation fluid from the the formation 112.

The information handling system 122 in direct or indirect communication with the BHA 134 may be used to gather, store, process, communicate, and analyze the data from the fluid sampling and analysis system 114 and other inputs and optionally to control the RSS 130 or other BHA components. The information handling system 122 may include various spatially separated components, which may include various above-ground components (e.g. at a surface of the well site and/or a remote location) and/or below-ground components, such as a downhole information handling subsystem. Such distributed or spatially separated components may be connected over a network or other suitable electronic communication medium. Thus, processing, storing, and/or analyzing of information may occur at different locations and times, and may occur partially downhole, partially at the surface 108 of the well site, and/or partially at a remote location, such as another well site or a remote data processing center. Sensor data and other information processed downhole may be transmitted to the surface 108 to be recorded, observed, and/or further analyzed at the surface or remote site. Additionally, information recorded on the information handling system 122 that may be disposed downhole may be stored until the BHA 134 may be brought to the surface 108. In some examples, the information handling system 122 may communicate with the BHA 134 through the telemetry system 129 (e.g., mud pulse, magnetic, acoustic, wired pipe, or combinations thereof) in real-time mode. The information handling system 122 may transmit information to the BHA 134 and may receive as well as process information recorded by BHA 134.

Generally, components of the information handling system 122 may include memory 140, one or more processor 150, and a user interface 162. Memory 140 may comprise any of a variety of electronic memory devices, such as one or more long-term memory 143, one or more short-term memory 145, and a non-transitory computer-readable media (“CRM”) 146. For the purposes of this disclosure, the CRM 146 may include any instrumentality or aggregation of instrumentalities that may retain data and/or instructions for a period of time. The CRM 146 may include, for example, without limitation, storage media such as a direct access storage device (e.g., a hard disk drive or floppy disk drive), a sequential access storage device (e.g., a tape disk drive), compact disk, CD-ROM, DVD, RAM, ROM, electrically erasable programmable read-only memory (EEPROM), and/or flash memory; as well as communications media such wires, optical fibers, microwaves, radio waves, and other electromagnetic and/or optical carriers; and/or any combination of the foregoing. The long-term memory 143 may be structured, for example, as read only memory (ROM), which is a type of non-volatile memory for which data is not readily modified after the manufacture of the memory device. The short-term memory 145 may be structured, for example, as random access memory (RAM), which in contrast to ROM or Flash, can be read and changed. For example, short-term memory may be used to temporarily store information such as computer executable instruction code (e.g., from software) and/or data from the BHA 134 for processing by a processor 150. The non-transitory CRM 146 may comprise a device or structure on which computer executable instructions, data, and other information may be stored in a non-transitory manner. The user interface 162 generally comprises one or more devices electronically connected or connectable to other components of the information handling system 122 for communicating information from or to a user (typically, a human user). The user interface 162 may include input/output (I/O) peripherals. Examples of peripherals for user input include a keyboard, mouse, stylus, track pad, touchscreen, smart goggles or glasses, a microphone, and biometric (e.g. fingerprint, retina, or facial recognition) sensors. Examples of peripherals that provide output for a user include a display, a speaker, a printer or other imaging device, a tactile feedback device, and smart goggles or glasses. Some of these peripherals provide both user input and user output.

The processor 150 may include a microprocessor or other suitable circuitry for processing information, such as for estimating, receiving and processing signals from the RSS 130 or other BHA components such as the fluid sampling and analysis system 114. The processor 150 may also, or instead, be embodied in an application specific integrated circuit, a programmable gate array, programmable array logic, or any other device or combinations of devices operable to process electric signals. The RSS 130 or information handling system 122 may also include one or more additional components, such as analog-to-digital converter, filter and amplifier, among others, that may be used to process the measurements of the BHA 134 before they may be transmitted to surface 108. Alternatively, raw measurements from the BHA 134 may be transmitted to surface 108.

Any suitable technique may be used for transmitting signals from the BHA 134 to surface 108, including, but not limited to available telemetry e.g., mud pulse, magnetic, acoustic, wired pipe, or combinations thereof). The telemetry system 129 may transmit telemetry data to surface 108. At the surface 108, pressure transducers (not shown) may convert the pressure signal into electrical signals for the surface receiver 131. The surface receiver 131 may supply a digital form of the telemetry signals to information handling system 122 via a communication link 139, which may be a wired or wireless link. The telemetry data may be analyzed and processed by the information handling system 122. A communication link 139 (which may be wired or wireless, for example) may be provided that may transmit data from the BHA 134 or downhole information handling subsystem to components of the information handling system 122 at the surface 108. Alternatively, the communications link 139 may be provided to transmit data to and from the surface receiver 131.

The information handling system 122 described above thus represents any of a broad range of different configurations. The information handling system 122, in any of its configurations, may be used in performing all or part of the methods and controlling all or part of the systems further described herein for implementing formation fluid sampling and analysis. For example, the information handling system 122 may be used to process data from the BHA 134 and other inputs to analyze properties of formation fluid.

FIG. 1B illustrates a schematic view of another embodiment of the well 102 in which an example embodiment of the fluid sampling and analysis system 114 may be deployed. As illustrated, a wireline system 101 includes the fluid sampling and analysis system 114 deployed as part of a wireline assembly 115, either onshore of offshore. As illustrated, the wireline assembly 115 may include a winch 117 for example, to raise and lower a downhole portion of the wireline assembly 115 into the well 102. The fluid sampling and analysis system 114 includes a fluid sampling tool 170 attached to the winch 117 and supported by the rig 172 at the surface 108. As with the drilling system 100, the wireline system 101 includes an information handling system 122 communicatively coupled to the fluid sampling tool either by way of communication link 139, which may be by way of the cable 15. In certain embodiments, the information handling system 122 may serve as the computing facilities of the logging facility 44.

The fluid sampling tool 170 is shown tethered to the winch 117 through a wireline 174. While FIG. 1B illustrates the wireline 174, it should be understood that other suitable conveyances may also be used for providing mechanical conveyance to fluid sampling tool in the well 102, including, but not limited to, slickline, coiled tubing, pipe, drill pipe, drill string, downhole tractor, or the like. In some examples, the conveyance may provide mechanical suspension, as well as electrical connectivity, for fluid sampling tool 170. The wireline 174 may include, in some instances, a plurality of electrical conductors extending from the winch 117. By way of example, the wireline 174 may include an inner core of seven electrical conductors (not shown) covered by an insulating wrap. An inner and outer steel armor sheath may be wrapped in a helix in opposite directions around the conductors. The electrical conductors may be used for communicating power and telemetry downhole to the fluid sampling tool 170.

With reference to both FIGS. 1A and 1B, operation of fluid sampling tool 170 for sample collection will now be described in accordance with example embodiments. The fluid sampling tool 170 may be raised and lowered into the well 102 on the drill string 120 (FIG. 1A) or the wireline 174 (FIG. 1B). The fluid sampling tool 170 may be positioned downhole to obtain fluid samples from the subterranean formation 112 for analysis. The formation fluid and, thus the fluid sample may be contaminated with, or otherwise contain, one or more chemically active components. In some embodiments, the chemically active component may be contained in the fluid sample in small quantities, for example, less than 500 parts per million (“ppm”). For example, the chemically active component may be present in the fluid sample in an amount from about 1 ppm to about 500 ppm, about 100 ppm to about 200 ppm, about 1 ppm to about 100 ppm, or about 5 to about 10 ppm. In other instances a small but not trace concentration of H₂S in the percent ranges from 0.1% to 1%, 1% to 5% or from 5% to 20% are of interest and can be monitored with a chemical additive designed for less reactivity. In other instances, the chemically additive component may be present in part per billion or part per trillion concentrations as in the case of mercury. In other instances the chemically active component may be present at higher concentrations above 500 ppm or even above 1%. The fluid sampling tool 170 may be operable to measure data regarding the fluid from the subterranean formation 112 and either the fluid sampling tool 170 itself or the BHA 134 may be operable to process and communicate the data to the information handling system 122. The fluid sample may be analyzed, for example, to determine the presence of and to quantify the concentration of the chemically active component within the formation fluid. This information including information gathered from analysis of the fluid sample, may be used by well operators to determine, among other things, the concentration the chemically active component within the fluid being extracted from the subterranean formation 112. The presence and concentration of the chemically active component may also be used to make intelligent decisions about ongoing operation of the well 102, including, in the case of the drilling system 100, controlling the drilling system 100 to either cease or continue drilling operations or to control the RSS 130 to change the direction of the borehole 104 based on the analysis. For example, the BHA 134 may receive instructions from a well operator via the information handling system 122 to operate the fluid sampling tool 170 or to operate the RSS 130. Alternatively, the BHA 134 may receive instructions from the information handling system 122 itself to operate the fluid sampling tool 170 or the drilling system 100, for example to continue or stop drilling operations or to control the RSS 130 to adjust the direction of drilling. For example, if the presence of a chemically active component is detected and in such a concentration to indicate that the fluid sample may not be suitable for production, the drilling system 100 may be controlled to continue to drill the borehole 104 to reach a different depth or steer the borehole 104 in a different direction. The chemically active component may also indicate favorable production conditions and the drilling system 100 may be controlled to stop drilling the borehole 104 further.

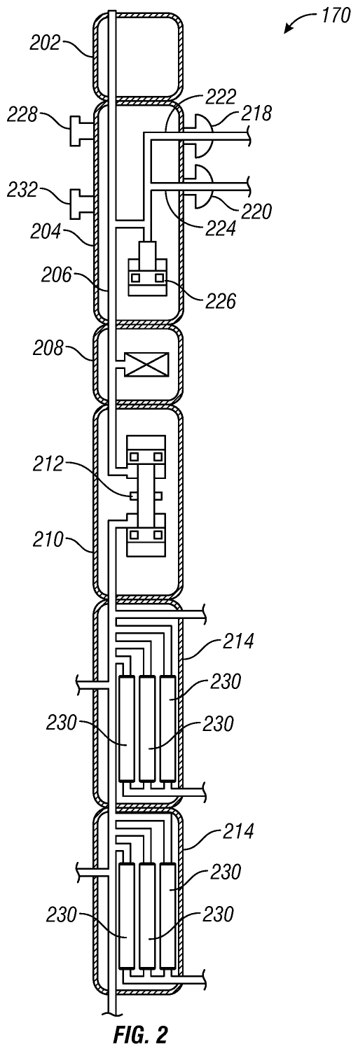

Referring now to FIG. 2, an example embodiment of a fluid sampling tool 170 is illustrated as a tool for gathering fluid samples from a formation for subsequent analysis and testing. It should be understood that the fluid sampling tool 170 shown on FIG. 2 is merely illustrative and the example embodiments disclosed herein may be used with other tool configurations. In an embodiment, the fluid sampling tool 170 includes a transceiver 202 through which the fluid sampling tool 170 may communicate with other actuators and sensors in a conveyance (e.g., the drill string 120 on FIG. 1A or wireline 174 on FIG. 1B), the conveyance's communications system (e.g., the BHA 134), and with a surface controller (e.g., the information handling system 122 on FIG. 1A). In one or more embodiments, the transceiver 202 is also the port through which various actuators (e.g. valves) and sensors (e.g., temperature and pressure sensors) in the fluid sampling tool 170 are controlled and monitored by, for example, a computer or processor in another part of the conveyance or the wireline assembly 115 or by the information handling system 122. In one or more embodiments, the transceiver 202 includes a computer or processor that exercises the control and monitoring function.

The fluid sampling tool 170 may include a dual probe section 204, which extracts fluid from the formation (e.g., formation 112 on FIGS. 1A and 1B), as described in more detail below, and delivers it to a channel 206 that extends from one end of the fluid sampling tool 170 to the other. The channel 206 can be connected to other tools or portions of the fluid sampling tool 170 arranged in series. The fluid sampling tool 170 may also include a gauge section 208, which includes sensors to allow measurement of properties, such as temperature and pressure, of the fluid in the channel 206. The fluid sampling tool 170 may also include a flow-control pump-out section 210, which includes a pump 212 for pumping fluid through the channel 206. The fluid sampling tool 170 also includes one or more sample chambers, such as in multi-chamber sections 214, which are described in more detail below.

In one or more embodiments, the dual probe section 204 includes two probes 218, 220 that extend from the fluid sampling tool 170 and press against the borehole wall to receive fluid for sampling. Probe channels 222, 224 connect the probes 218, 220 to the channel 206. The pump 212 is operable to pump fluids from the reservoir, through the probe channels 222, 224, and to the channel 206. Alternatively, a low volume pump 226 is operable for this purpose. Two standoffs or stabilizers 228, 232 hold the fluid sampling tool 170 in place as the probes 218, 220 press against the borehole wall to receive fluid. The probes 218, 220 and stabilizers 228, 232 may be retracted when the tool is in motion and extended to gather samples of fluid from the formation.

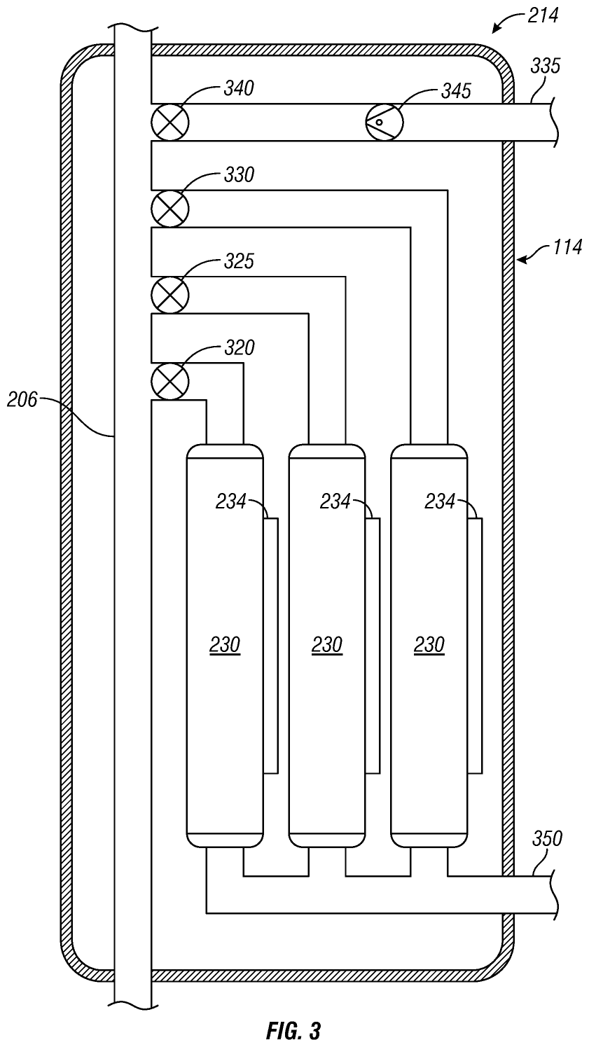

With additional reference to FIG. 3, the multi-chamber sections 214 include multiple sample chambers 230. While FIGS. 2 and 3 show the multi-chamber sections 214 having three sample chambers 230, it should be understood that the multi-chamber sections 214 can have any number of sample chambers 230 and may in fact be single sample chamber sections. The sample chambers 230 may be coupled to the channel 206 through respective chamber valves 320, 325, 330. Each sample chamber 230 is designed to be placed in the fluid sampling tool 170 prior to the formation test, isolated once the formation fluid is received, and then removed from the fluid sampling tool 170 after the test. For the formation test, formation fluid can be directed from the channel 206 to a selected one of the sample chambers 230 by opening the appropriate one of the chamber valves 320, 325, 330. The valves 320, 325, 330 may be configured such that when one of the chamber valves 320, 325, 330 is open the others are closed or alternatively any combination of sample chamber valves 320, 325, 330 may be open or closed. Alternatively, the chamber valves 320, 325, 330 may be check valves set with a minimum pressure overburden that allow fluid flow into the chambers 230 upon sufficient pressure but not in the opposite direction. The chamber valves 320, 325, 330 may also be other types of valves, such as burst disks. Alternatively, the sample chambers 230 may be individually physically moved into fluid communication with the channel 206 using a linear actuator or other mechanism. Also alternatively, instead of individual chamber valves 320, 325, 330, the multi-chamber section 214 may include a single valve that controls flow of formation fluid into the sample chambers 230. For example, the multi-chamber section 214 may include a piston valve moveable on a rod. The piston would be designed to allow fluid flow into one sample chamber 230 at a time and be movably positioned by an actuator such as a screw drive driven by a stepper motor controlled to select which sample chamber 230 to open for fluid flow. Alternatively, the single valve may include a multi-port injection valve operable, e.g., by rotation, to introduce a determined amount of the formation fluid into one or more of the sample chambers 230. Additionally, the sample chambers 230 may be located along a long distance of the channel 206 to prevent mixing of multiple formation fluids.

In one or more embodiments, each sample chamber 230 includes a sensor 234 operable to read or detect the presence of a reaction product from the interaction of a chemically active component and a reagent (described further below). From the detection of the reaction product, the presence and concentration of the chemically active component in the formation fluid sample in the sample chamber 230 may be determined. The detection may be qualitative, semi-quantitative, or quantitative. For example, the sensors 234 may detect a change in one or more properties of the reagent system based on an interaction with the chemically active component as well as the dimensions of a reacted zone where the chemically active component has reacted with the reagent in a sample chamber 230. The sensors 234 may be different sensors suitable for detecting the reaction product formed from the interaction of the chemically active component with the reagent system. For example, the sensors may be one or more of an optical sensor, an electrical sensor, or an acoustic sensor, among others. Different combinations of sensors may also be used, even on the same sample chamber 230. The changes may be detected using different suitable mechanisms, such as optical measurement of changes in the reagent system optical properties such as color, electrical measurements for change in the electrical properties of the reagent system, and acoustic properties that measure changes in the acoustic properties of the reagent system. For optical sensors (or other sensors as well), the sample chamber 230 may include a housing at least a portion of which is transparent such that the optical sensor and detect changes inside the sample chamber 230. The sensors 234 may read only a portion of the length of a sample chamber 230 or may read over an entire length of the sample chamber 230. Further, if multiple sensors 234 are used on one sample chamber 230, the readings of the sensors 234 may be integrated over the entire volume of the sample chamber 230 to determine the total reacted concentration of the reaction product, especially where there is a partially reacted zone in the reagent system. Additionally, all or a portion of a sensors 234 may extend into the interior of a sample chamber 230 such that the reading can be done internal to the sample chamber 230.

In some embodiments, the multi-chamber sections 214 may include a path 335 from the channel 206 to the annulus 160 through a valve 340. The valve 340 may be open during a draw-down period when the fluid sampling tool 170 is clearing mud cake, drilling mud, and other contaminants into the annulus before clean formation fluid is directed to one of the sample chambers 230. A check valve 345 prevent fluids from the annulus 160 from flowing back into the channel 206 through the path 335. Additionally, the multi-chamber sections 214 may include a path 350 from the sample chambers 230 to the annulus 160 such that fluid may flow out of the sample chambers 230. Similar to controlling fluid flow into the inlet of each sample chamber 230, an exit valve or valves (not shown) may be included to control fluid flow out of each sample chamber 230 and into the path 350. For example, the exit valve may be a burst valve openable upon a minimum pressure within the sample chambers 230. In addition, while FIG. 3 shows the sample chambers 230 arranged in parallel, it should be understood that the sample chambers 230 can also be arranged in series, or a combination of series and parallel.

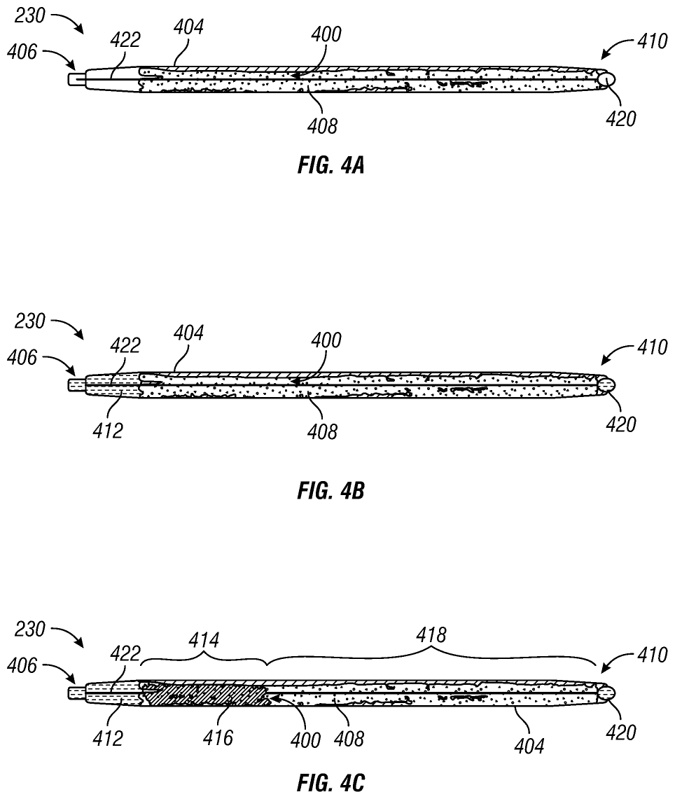

FIGS. 4A-4C illustrate cross-sectional views of an example embodiment of a sample chamber 230 containing a reagent system 400 for receiving formation fluid 402 with a chemically active component. As illustrated, the sample chamber 230 includes a housing 404 that includes an inlet 406 for receiving the formation fluid into an interior 408 and an outlet 410. The reagent system 400 is in the interior 408 and includes a substrate coated with a reagent and supported by scaffolding. An interconnected porosity extending through the reagent system 400 exposes the reagent to potential interaction with a fluid sample that enters the sample chamber 230. The substrate may be any suitable substrate for attaching the reagent, such as glass beads, sand, hydrogel, silicone, polymers, or silica particles. Additionally, the substrate may have a large surface area to volume ratio and may be transparent or semitransparent to the energy type used for measurement such as optical energy, RF energy, x-ray energy, acoustic energy, particle energy, or the like. The substrate may be contained within a scaffolding especially in order to maintain the permeability and porosity of the system but also the shape, and to prevent corrosion. The scaffolding may be any suitable scaffolding for supporting the reagent coated substrate, for example sand or silica or glass balls, ceramic balls, or the like such that the substrate is not reactive with the component of interest. The reagent may comprise a consumable reagent, i.e., irreversible, and the reagent used depends on the chemically active component being analyzed. For example, the reagent may be a material reactive to the chemically active component such as lead acetate, which is reactive to H₂S to form lead sulfide, or amines that are reactive to CO2. The reagent may react by chemical and or physical means to the presence of the chemically active component. Further, the reagent may be a reagent suitable for titrimetric or colorimetric analysis such as tests for total hardness, alkalinity, chlorine, formaldehyde, aluminum, nitrite, ammonium, sulfide, phosphate, or combinations thereof. Further, the reagent may be a reagent suitable as an indicator for titration such as phenolphthalein, Hematoxylin, Methyl red (C.I. 10320), Phenol red, pH indicator solution, bromophenol, indicator buffer, methyl orange, 1-naphtholbenzein, thymol blue, zylenol orange tetrasodium salt, crystal violet (C.I. 42555), chromotropic acid disodium salt dihydrate, calcon (C.I. 15705), thymolphthalein, dithizone, thorin, cresol red, indigo carmine (C.I. 73015), calconcarboxylic acid, or combinations thereof. Further, the reagent may be a complex or metal indicator, an acid-alkali (pH) indicator, a fluorescence indicator, or combinations thereof. A sufficiently similar reagent system may negate the need for a baseline measurement, however, a before and after exposure set of measurements may be necessary to provide a baseline to the after measurement.

With the inlet 406 of a particular sample chamber 230 opened as explained above, the sample chamber 230 is available to receive formation fluid that contains the chemically active component. In addition to, or alternatively, one or more of the sample chambers 230 may include a unidirectionally diffusion limited path allowing formation fluid to flow in (a fast process) but requiring it to diffuse out (a slow process). For example, as the shape of the reagent system is maintained by the scaffolding and or substrate in some embodiments, or is naturally maintained in others as would be the case with a bonded or interlaced substrate, then the length of the sample chamber 230 may be much longer than the diameter, providing a pseudo one dimensional path for diffusion to follow. The tube like structure may be twisted or bent but maintain the overall one dimensional behavior. Although one dimensional behavior is beneficial for measurement because a linear distance of the reaction product may be determined in order to measure the reaction extent, two dimensional or three dimensional structures are also able to be utilized by monitoring the reaction extent more directly. Two dimensional structures may have some benefit over three dimensional structures in that the reaction extent may be monitored as a surface area measurement over the structure. Volumetric measurements in a three dimensional structure are measurable as a plum.

Depending on the chemically active component and reagent system, a specific inflow and outflow of the formation fluid into and out of the sample chamber 230 may be desired. The physical shape of a sample chamber 230 may also assist in controlling the flow of formation fluid with respect to the sample chamber 230. For example, an elongated form of the sample chamber as shown in FIGS. 4A-4C minimizes partially reacted zones of the reagent system 400, thus assisting in making direct sensor readings more consistent. It should be understood however that alternate shapes of the sample chamber 230 may be more convenient for placement into the sampling tool 170.

Also, the intensity of the reaction product due to the reaction of the chemically active component and the reagent may be integrated over part of the shape or the whole shape of the sample chamber 230 in order to provide a quantitative measurement of the chemically active component. For example, as shown in FIGS. 4A-4C, the elongated shape promotes the reading of the concentration in a linear fashion, similar to a thermometer. As shown in FIG. 4A, initially the sample chamber 230 may be closed or at least formation fluid has not yet entered the sample chamber 230. In FIG. 4B, the inlet 406 of the sample chamber 230 has been opened and formation fluid 412 has begun to flow into the interior 408, but has not yet begun to interact with the reagent system 400. In FIG. 4C, the formation fluid 412 has begun to interact with the reagent system 400, forming a reacted zone 414 of a reaction product 416 as a result of the reaction between the chemically active component of the formation fluid 412 and the reagent of the reagent system 400. As shown in FIG. 4C, the elongated shape of the sample chamber 230 may provide a sharp contrast between the active chemical reacted zone 414 and an unreacted zone 418 of unreacted reagent. The amount of the reacted zone 414 can easily be determined and hence the total active chemical species accounted by limited reaction. The reacted zone 414 can thus be used to determine the concentration of the chemically active component in the formation fluid with respect to the introduced quantity of the formation fluid (e.g., mass or volume, etc.). It should be understood that the reacted zone 414 shown in FIG. 4C is only an example that the size of the reacted zone may vary depending on the formation fluid and the reagent system used.

For the analysis, while the chemically active component in the formation fluid 412 is flowing into the sample chamber 230 and reacting with the reagent to form the reaction product in the reacted zone 414, one or more of the sensors 234 are monitoring the sample chamber 230 to detect the reaction product. This detection and measurement may be ongoing until the reaction concludes and no additional reaction product is generated. The measurement data from the sensor 234 may then be communicated by the sensor as a signal and either be stored in memory within the BHA 134 for later retrieval and analysis or telemetered to the information handling system 122 at the surface for analysis. Additionally, the sampling tool 170 may be calibrated based on a global calibration to products of the reagent system 400, may be calibrated by batch, or maybe calibrated individually by introducing an amount of reactant that does not consume the reagent system in its entirety.

The sample chamber 230 may also be designed to be sealed off after the formation fluid has entered the sample chamber 230. For example, the sample chamber 230 may be sealed by a self-setting epoxy resin that cures upon contact with the formation fluid or upon a mixing of the two or more other fluids. The mixing fluid or fluids may be located at the front or back of the sample chamber 230 in a container 420, e.g., a glass bulb, that breaks when pressurized. The breaking of the container 420 mixes the epoxy and forces expansion of the epoxy through a channel 422 and into the inlet 406, sealing the sample chamber 230 as shown in FIGS. 4B and 4C. A pressure release valve (not shown) in the outlet 410 is operable to release pressure as the fluid in the sample chamber 230 comes to surface, preventing rupturing of the capsule. This will take place after sufficient time that the reaction has largely completed.

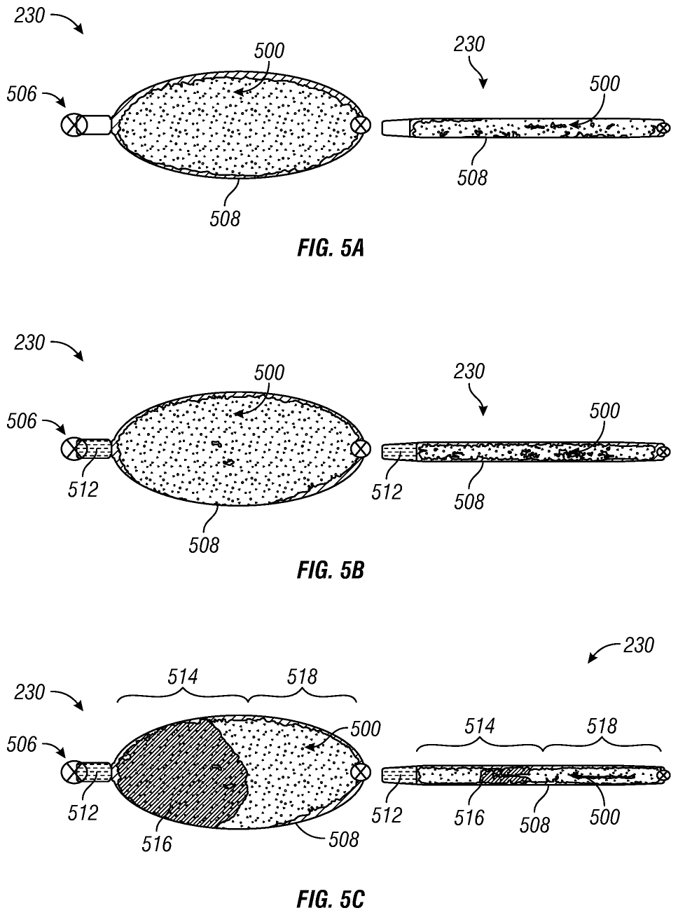

Alternatively, as shown in FIGS. 5A-5C, the sample chamber 230 may be flat, which promotes reading the signals from the axis perpendicular to the oblate face. As shown in FIG. 5A, initially the sample chamber 230 may be closed or at least formation fluid has not yet entered the sample chamber 230. In FIG. 5B, the inlet 506 of the sample chamber 230 has been opened and formation fluid 512 has begun to flow into the interior 508, but has not yet begun to interact with the reagent system 500. In FIG. 5C, the formation fluid 512 has begun to interact with the reagent system 500, forming a reacted zone 514 of a reaction product 516 as a result of the reaction between the chemically active component of the formation fluid 512 and the reagent of the reagent system 500. As shown in FIG. 5C, the elongated shape of the sample chamber 230 may provide a sharp contrast between the active chemical reacted zone 514 and an unreacted zone 518 of unreacted reagent. The amount of the reacted zone 514 can easily be determined and hence the total active chemical species accounted by limited reaction. The reacted zone 514 can thus be used to determine the concentration of the chemically active component in the formation fluid with respect to the introduced quantity of the formation fluid (e.g., mass or volume, etc.). It should be understood that the reacted zone 514 shown in FIG. 5C is only an example that the size of the reacted zone may vary depending on the formation fluid and the reagent system used.

In one or more embodiments, the chemically active component measurements may be extrapolated to reservoir conditions. Extrapolation may be performed, for example, using measurements of the chemically active component from more than one sample chamber 230. The fluid sample may be acquired in each of the more than one sample chamber 230 downhole at during the same pump out or at different times. Any suitable technique may be used for extrapolating the chemically active component measurement to reservoir conditions, including, but not limited to, equations of state and geodynamic modeling, among others.

The sample chamber 230 may also be at least partially filled with a compensating fluid such that the introduction of the formation fluid does not “flash” or burst into the sample chamber 230 under high pressure. Thus, the compensating fluid is configured to decrease the flow rate of the formation fluid sample into the interior of the sample chamber 230. Further, the compensating fluid may promote the dissipation of the formation fluid into the sample chamber 230 and reduce interference for the readings by the sensors 234 and standardize the reading matrix. The choice of a compensating fluid should be compatible with the matrix of the formation fluid as to promote the dispersion. As such, organic solvents that promote fluid stability such as but not limited to carbon disulfide, toluene, benzene, xylene may be suitable as compensating fluid. However, the solvent should not interfere with the reagent's affinity to the chemically active component being measured. Example solvents that may be appropriate include toluene, xylene, isopropyl alcohol, water, pentane, hexane, heptane, or mineral oil.

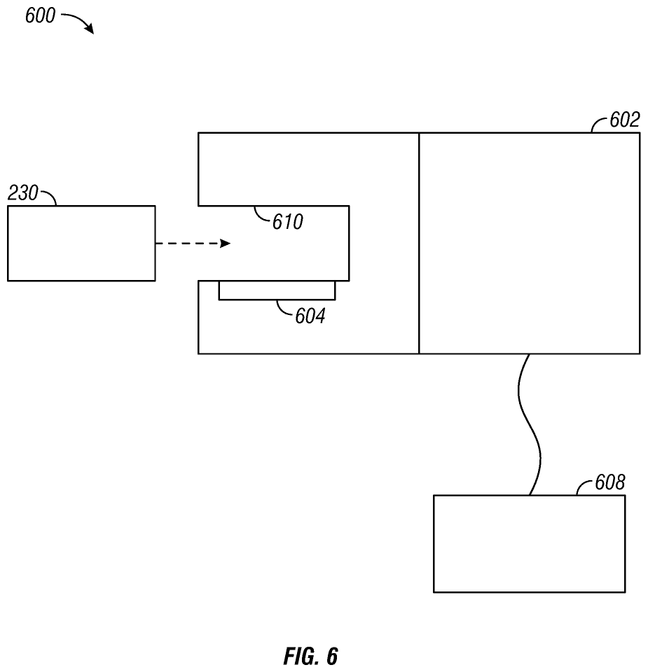

In one or more embodiments, the sample chamber 230 may either be read in place in the sampling tool 170 or the sample chamber 230 may be removed from the sampling tool 170 and read in or with the aid of a separate device. For example, FIG. 6 illustrates an example of a test system 600 for chemically active component measurement at the surface. As illustrated, the test system 600 includes a chamber housing 602, a fluid analyzer 604, and a processor 608. The chamber housing 602 may include a chamber receptacle 610 for receiving the sample chamber 230 after the sample chamber 230 has been removed from the sampling tool 170. The sample chamber 230 may contain, for example, a fluid sample of a formation fluid taken during a formation fluid test while downhole. As previously described, the fluid sample may contain a chemically active component.

It may be desired to detect the presence and quantify the concentration of the chemically active component in the fluid sample. To do so, the chamber housing 602 may receive the sample chamber 230 in the chamber receptacle 610. The test system 600 may further include a fluid analyzer 604, such as sensor 234 discussed above, for analyzing the chemically active component in the chamber housing 602. The chamber housing 602 may be opened (or otherwise) accessed so that the sample chamber 230 can be provided into the chamber receptable 610 for analysis by the fluid analyzer 604. The fluid analyzer 604 may use any of a variety of suitable analysis techniques for analyzing the fluid sample to quantify concentration of the chemically active component. Suitable analysis techniques may include electrical sensors, optical sensors, and acoustic sensors as discussed above but may also include other measurement equipment and techniques such as gas chromatography and mass spectrometry.

The test system 600 may further include a processor 608. As with the information handling system 122, the processor 608 may be operable for processing instructions, including, but not limited to, a microprocessor, microcontroller, embedded microcontroller, programmable digital signal processor, or other programmable device. The processor 608 may also, or instead, be embodied in an application specific integrated circuit, a programmable gate array, programmable array logic, or any other device or combinations of devices operable to process electric signals. The processor 608 is communicatively coupled with the fluid analyzer 604, which may be a wired connection or a wireless connection, as desired for a particular application.

In some embodiments, the processor 608 can be configured to receive inputs from the fluid analyzer 604, for example, to determine a concentration of the chemically active component in the fluid sample. The fluid analyzer 604, for example, may determine a total quantity (e.g., volume, moles, etc.) of the chemically active component. Since of a total volume of the fluid sample in the sample chamber is known, the concentration of the chemically active component in the fluid sample can then be determined with the total quantify of the chemically active component.

Examples of the above embodiments include:

Example 1 is a fluid sampling tool locatable in a borehole extending in a subterranean formation and for sampling formation fluid including a chemically active component from the formation. The tool comprises: a sample chamber comprising a fluid inlet and an interior, wherein the interior comprises a substrate and a reagent attached to the substrate, and wherein the reagent is configured to react with the chemically active component of the formation fluid to form a reaction product; a probe extendable to engage the subterranean formation from the borehole; and a pump operable to pump a sample of the formation fluid in from the formation through the probe and into the sample chamber.

In Example 2, the embodiments of any preceding paragraph or combination thereof further include a sensor operable to detect the reaction product such that the presence and concentration of the chemically active component in the formation fluid sample in the sample chamber is determinable by a processor based on a signal from the sensor.

In Example 3, the embodiments of any preceding paragraph or combination thereof further include wherein the sensor comprises at least one of an optical, electrical, or acoustic sensor.

In Example 4, the embodiments of any preceding paragraph or combination thereof further include wherein the sensor is located in the fluid sampling tool.

In Example 5, the embodiments of any preceding paragraph or combination thereof further include more than one sample chamber.

In Example 6, the embodiments of any preceding paragraph or combination thereof further include wherein at least two sample chambers comprise different reagents configured to react to different chemically active components.

In Example 7, the embodiments of any preceding paragraph or combination thereof further include wherein the sample chamber further comprises a compensating fluid in the interior configured to decrease a flow rate of the formation fluid sample into the interior and dissipate the formation fluid sample in the sample chamber.

In Example 8, the embodiments of any preceding paragraph or combination thereof further include a valve operable to control flow of the formation fluid sample into the sample chamber.

Example 9 is a method for sampling formation fluid from a subterranean formation, comprising: inserting fluid sampling tool into a borehole extending in the formation; extending a probe from the fluid sampling tool into contact with the formation; operating a pump of the fluid sampling tool to pump the formation fluid in from the formation through the probe to collect a formation fluid sample; flowing the formation fluid sample into a sample chamber comprising a fluid inlet and an interior, wherein the interior comprises a substrate and a reagent attached to the substrate; and reacting a chemically active component of the formation fluid sample with the reagent in the sample chamber to form a reaction product from which a presence and concentration of the chemically active component in the formation fluid sample is determinable.

In Example 10, the embodiments of any preceding paragraph or combination thereof further include: detecting, using a sensor, the reaction product; and determining, using a processor, the presence and concentration of the chemically active component in the formation fluid in the sample chamber based on the detection by the sensor.

In Example 11, the embodiments of any preceding paragraph or combination thereof further include wherein the sensor comprises at least one of an optical, electrical, or acoustic sensor.

In Example 12, the embodiments of any preceding paragraph or combination thereof further include collecting more than one formation fluid sample and placing the formation fluid samples in different sample chambers.

In Example 13, the embodiments of any preceding paragraph or combination thereof further include reacting different chemically active components in the formation fluid samples with different reagents in different sample chambers.

In Example 14, the embodiments of any preceding paragraph or combination thereof further include: decreasing a flow rate of the formation fluid sample into the sample chamber using a compensating fluid in the sample chamber interior; and dissipating the formation fluid sample in the sample chamber using the compensating fluid.

In Example 15, the embodiments of any preceding paragraph or combination thereof further include controlling the flow of the formation fluid sample into the sample chamber using a valve.

Example 16 is a fluid sample chamber locatable in a borehole extending in a subterranean formation and for sampling formation fluid including a chemically active component from the formation, comprising a sample chamber comprising a fluid inlet and an interior, wherein the interior comprises a substrate and a reagent attached to the substrate, and wherein the reagent is configured to react to the chemically active component of the formation fluid such that a presence and concentration of the chemically active component is determinable.

In Example 17, the embodiments of any preceding paragraph or combination thereof further include a sensor operable to detect the presence and concentration of the chemically active component in the formation fluid sample in the sample chamber based on a reaction with the reagent.

In Example 18, the embodiments of any preceding paragraph or combination thereof further include wherein the sensor comprises at least one of an optical, electrical, or acoustic sensor.

In Example 19, the embodiments of any preceding paragraph or combination thereof further include a compensating fluid in the interior configured to decrease a flow rate of the formation fluid sample into the interior and dissipate the formation fluid sample in the sample chamber.

In Example 20, the embodiments of any preceding paragraph or combination thereof further include a valve operable to control flow of the formation fluid sample into the sample chamber.

Certain terms are used throughout the description and claims to refer to particular features or components. As one skilled in the art will appreciate, different persons may refer to the same feature or component by different names. This document does not intend to distinguish between components or features that differ in name but not function.

For the embodiments and examples above, a non-transitory computer readable medium can comprise instructions stored thereon, which, when performed by a machine, cause the machine to perform operations, the operations comprising one or more features similar or identical to features of methods and techniques described above. The physical structures of such instructions may be operated on by one or more processors. A system to implement the described algorithm may also include an electronic apparatus and a communications unit. The system may also include a bus, where the bus provides electrical conductivity among the components of the system. The bus can include an address bus, a data bus, and a control bus, each independently configured. The bus can also use common conductive lines for providing one or more of address, data, or control, the use of which can be regulated by the one or more processors. The bus can be configured such that the components of the system can be distributed. The bus may also be arranged as part of a communication network allowing communication with control sites situated remotely from system.

In various embodiments of the system, peripheral devices such as displays, additional storage memory, and/or other control devices that may operate in conjunction with the one or more processors and/or the memory modules. The peripheral devices can be arranged to operate in conjunction with display unit(s) with instructions stored in the memory module to implement the user interface to manage the display of information. Such a user interface can be operated in conjunction with the communications unit and the bus. Various components of the system can be integrated such that processing identical to or similar to the processing schemes discussed with respect to various embodiments herein can be performed.

While descriptions herein may relate to “comprising” various components or steps, the descriptions can also “consist essentially of” or “consist of” the various components and steps.

Unless otherwise indicated, all numbers expressing quantities are to be understood as being modified in all instances by the term “about” or “approximately”. Accordingly, unless indicated to the contrary, the numerical parameters are approximations that may vary depending upon the desired properties of the present disclosure. As used herein, “about”, “approximately”, “substantially”, and “significantly” will be understood by persons of ordinary skill in the art and will vary to some extent on the context in which they are used. If there are uses of the term which are not clear to persons of ordinary skill in the art given the context in which it is used, “about” and “approximately” will mean plus or minus 10% of the particular term and “substantially” and “significantly” will mean plus or minus 5% of the particular term.

The embodiments disclosed should not be interpreted, or otherwise used, as limiting the scope of the disclosure, including the claims. It is to be fully recognized that the different teachings of the embodiments discussed may be employed separately or in any suitable combination to produce desired results. In addition, one skilled in the art will understand that the description has broad application, and the discussion of any embodiment is meant only to be exemplary of that embodiment, and not intended to suggest that the scope of the disclosure, including the claims, is limited to that embodiment.

What is claimed is:

1. A fluid sampling tool locatable in a borehole extending in a subterranean formation and for sampling formation fluid including a chemically active component from the formation, comprising:
a sample chamber comprising a fluid inlet and an interior, wherein the interior comprises a substrate and a reagent attached to the substrate, and wherein the reagent is configured to react with the chemically active component of the formation fluid to form a reaction product;
a probe extendable to engage the subterranean formation from the borehole; and
a pump operable to pump a sample of the formation fluid in from the formation through the probe and into the sample chamber.

2. The tool of claim 1, further comprising a sensor operable to detect the reaction product such that the presence and concentration of the chemically active component in the formation fluid sample in the sample chamber is determinable by a processor based on a signal from the sensor.

3. The tool of claim 2, wherein the sensor comprises at least one of an optical, electrical, or acoustic sensor.

4. The tool of claim 2, wherein the sensor is located in the fluid sampling tool.

5. The tool of claim 1, further comprising more than one sample chamber.

6. The tool of claim 5, wherein at least two sample chambers comprise different reagents configured to react to different chemically active components.

7. The tool of claim 1, wherein the sample chamber further comprises a compensating fluid in the interior configured to decrease a flow rate of the formation fluid sample into the interior and dissipate the formation fluid sample in the sample chamber.

8. The tool of claim 1, further comprising a valve operable to control flow of the formation fluid sample into the sample chamber.

9. A method for sampling formation fluid from a subterranean formation, comprising:
inserting fluid sampling tool into a borehole extending in the formation;
extending a probe from the fluid sampling tool into contact with the formation;
operating a pump of the fluid sampling tool to pump the formation fluid in from the formation through the probe to collect a formation fluid sample;
flowing the formation fluid sample into a sample chamber comprising a fluid inlet and an interior, wherein the interior comprises a substrate and a reagent attached to the substrate; and
reacting a chemically active component of the formation fluid sample with the reagent in the sample chamber to form a reaction product from which a presence and concentration of the chemically active component in the formation fluid sample is determinable.

10. The method of claim 9, further comprising:
detecting, using a sensor, the reaction product; and
determining, using a processor, the presence and concentration of the chemically active component in the formation fluid in the sample chamber based on the detection by the sensor.

11. The method of claim 10, wherein the sensor comprises at least one of an optical, electrical, or acoustic sensor.

12. The method of claim 9, further comprising collecting more than one formation fluid sample and placing the formation fluid samples in different sample chambers.

13. The method of claim 12, further comprising reacting different chemically active components in the formation fluid samples with different reagents in different sample chambers.

14. The method of claim 9, further comprising:
decreasing a flow rate of the formation fluid sample into the sample chamber using a compensating fluid in the sample chamber interior; and
dissipating the formation fluid sample in the sample chamber using the compensating fluid.

15. The method of claim 9 further comprising controlling the flow of the formation fluid sample into the sample chamber using a valve.

16. A fluid sample chamber locatable in a borehole extending in a subterranean formation and for sampling formation fluid including a chemically active component from the formation, comprising a sample chamber comprising a fluid inlet and an interior, wherein the interior comprises a substrate and a reagent attached to the substrate, and wherein the reagent is configured to react to the chemically active component of the formation fluid such that a presence and concentration of the chemically active component is determinable.

17. The fluid sample chamber of claim 16, further comprising a sensor operable to detect the presence and concentration of the chemically active component in the formation fluid sample in the sample chamber based on a reaction with the reagent.

18. The fluid sample chamber of claim 17, wherein the sensor comprises at least one of an optical, electrical, or acoustic sensor.

19. The fluid sample chamber of claim 16, further comprises a compensating fluid in the interior configured to decrease a flow rate of the formation fluid sample into the interior and dissipate the formation fluid sample in the sample chamber.

20. The fluid sample chamber of claim 16, further comprising a valve operable to control flow of the formation fluid sample into the sample chamber.
